(19) United States
(12) Patent Application Publication
(10) Pub. No.: US 2006/0238626 A1
(43) Pub. Date: Oct. 26, 2006

(54) System and method of recording and playing back pictures

(75) Inventor: Reinhard Steiner, Bronschhofen (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Dynaslice AG, Zugerstrasse (CH)

(21) Appl. No.: 11/455,422

(22) Filed: Jun. 19, 2006

(30) Foreign Application Priority Data
Jun. 28, 2002 (CH) 01089/05

(51) Int. Cl. H04N 5/76

(52) U.S. Cl. 348/231.6

(57) ABSTRACT

A system for recording and playing back pictures of objects according to the time slice technology comprises a camera arrangement including several cameras simultaneously capturing pictures of at least one object, a storage assembly for storing all captured pictures, a display assembly for displaying captured pictures, and a control unit for controlling the camera arrangement, the storage assembly and the display assembly. The cameras, in each case, are high speed video cameras having high resolution adapted to capture a great number of pictures per second which all are stored in the storage assembly and then can be retrieved from the storage assembly in arbitrary sequence for creating movie sequences. A related method comprises the steps of simultaneous capturing of pictures of an object by means of several cameras of a camera assembly, whereby said several cameras in each case are high speed high resolution video cameras adapted to capture a great number of pictures per second, storing all captured pictures in a storage means or in several storage means, displaying the captured pictures on a display assembly, and selecting desired pictures from the stored pictures and/or displayed pictures and combining said selected pictures to movie sequences.

### BACKGROUND OF THE INVENTION

The present invention generally refers to a system and a method of recording and playing back pictures, particularly to be used in the production of movies. Even more particularly and in other words, the invention refers to a system and a method of recording and playing back pictures according to the so-called time slice technology, in which pictures, belonging to at least two different picture data streams, are recorded and played back.

### PRIOR ART

Such a system and method are disclosed, for example, in the document WO 96/019892 in which an apparatus is described, using an assembly of video cameras being able to record a plurality of photographic pictures of a scene from a plurality of different positions simultaneously and synchronously in rapid succession. For playing back, an operator can then chose an arbitrary sequence of pictures from the multitude of recorded pictures, with the result that particular effects can be realized if these pictures are played back properly arranged in a movie sequence.

Further such systems are disclosed in the documents WO 02/096096 and WO 03/041411. The document WO 02/096096 discloses a system with several individual photo cameras or video cameras, whereby pictures taken by these cameras are recorded to process them in such a way as to realize certain real time effects. The document WO 02/041411 discloses a video system comprising several remote controlled video cameras, whereby the pictures captured with these cameras are recorded in order to enable the pictures to be watched from different perspectives.

By simultaneously capturing and recording scenes or moving objects by means of several cameras, arranged at different locations and, in each case, capture a multitude of pictures per second, and by subsequently selecting recorded pictures for combining them, it is no longer necessary to move a camera for realizing pictures showing a motion. Moreover, by specially selecting and combining recorded pictures, special effects like slow-motion sequences, time lapsed sequences ant the like can easily be realized.

Even considering all advantages of the above mentioned prior art, systems for recording and playing back pictures by using the above mentioned time slice technology are difficult to operate. Furthermore, it is desirable to refine and to improve the effects realizable with a system and a method as known in the prior art.

### OBJECTS OF THE INVENTION

Thus, it is an object of the invention to simplify the operation of a system of recording and playing back pictures, particularly to be used in the production of movies, as it is disclosed, for example, in the document WO 96/019892. Moreover, is an object of the invention to improve a corresponding method.

### SUMMARY OF THE INVENTION

To meet these and other objects, the present invention provides, according to a first aspect, a system for recording and playing back pictures of objects according to the time slice technology. The system comprises a camera arrangement including several cameras simultaneously capturing pictures of at least one object, a storage assembly for storing all captured pictures, a display assembly for displaying captured pictures, and a control unit for controlling the camera arrangement, the storage assembly and the display assembly. The cameras, in each case, are high speed video cameras having high resolution adapted to capture a great number of pictures per second which all are stored in the storage assembly and then can be retrieved from the storage assembly in arbitrary sequence for creating movie sequences.

According to a second aspect, the invention also provides a method for recording and playing back pictures of objects according to the time slice technology. The method comprises the steps of simultaneous capturing pictures of an object by means of several cameras of a camera assembly, whereby said several cameras in each case are high speed high resolution video cameras adapted to capture a great number of pictures per second, storing all captured pictures in a storage means or in several storage means, displaying the captured pictures on a display assembly, and selecting desired pictures from the stored pictures and/or displayed pictures and combining said selected pictures to movie sequences.

By means of the control unit, for example a calibration and/or a synchronization of the system is performed before it is operated. Moreover, the cameras are controlled with regard to their capturing position on said support structure, with regard to their mutual synchronization considering their capturing position, and with regard to their capture operation and displaying operation. The display units are controlled with regard to their displaying operation. In the case of the storage assembly, the storage operations are controlled with regard to pictures captured by the camera assembly and with regard to pictures displayed by the display assembly. For storing the high number of pictures captured per second, additionally or alternatively, a plurality of storage devices can be provided, the number thereof corresponding to the number of cameras. In the case of selecting pictures for creating a movie sequence, the control unit can be used to automatically perform a rough pre-selection.

Thus, by means of the control unit, it can be achieved that particular operations of camera arrangement, display arrangement and storage assembly and/or several storage devices are synchronized. A monitoring of captured pictures is therefore possible even during recording. By means of the control unit provided by the system of the invention, the operation of the entire system is facilitated.

In the method according to the invention, a selection of pictures can be made from the displayed and/or from the stored pictures, with the result that both a selection of pictures can be performed directly during a recording session or at a later time. Thereby, the flexibility for an operator is increased.

Particularly the operability of the system is improved by the invention. By providing a plurality of high quality recording devices and cameras, respectively, a plurality of storage devices with very high storage capacity, a plurality of display units, and a control unit by means of which all components of the system can be controlled, the best special effects in a movie can be realized without the danger that an operator could be overstrained by operating the system.

The above mentioned as well as further characteristics and details of the invention will be even more obvious to a person skilled in the art from the following detailed description and the attached drawings.

### BRIEF DESCRIPTION OF THE DRAWINGS

In the following, an embodiment of the system and the method of the invention will be further described, with reference to the accompanying drawings, in which:

FIG. 1 shows a general schematic illustration of a system according to a preferred embodiment;

FIG. 2a shows a plurality of schematically illustrated cameras of a camera arrangement with assigned storage means of the system of FIG. 1;

FIG. 2b shows display units of a display arrangement of the system of FIG. 1; and

FIG. 3 shows a system according to a preferred embodiment in a practical application.

### DETAILED DESCRIPTION OF A PREFERRED EMBODIMENT

In the following, the present invention will be explained in detail considering as example a preferred embodiment and with reference to the accompanying drawings.

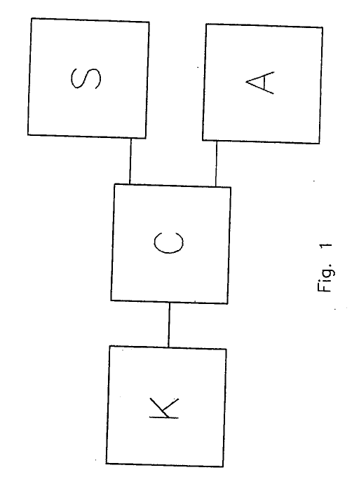

FIG. 1 shows a block diagram of a preferred embodiment of the system of the invention, comprising a camera assembly K, a display assembly A, a storage assembly S and a control unit C. The control unit is connected to the camera assembly K, with the display assembly A and with the storage assembly S in order to control these assemblies. This is accomplished by outputting a control signal from the control unit C to the camera assembly K, to the display assembly A and/or to the storage assembly, and, for monitoring of actual states of the controlled components, also by inputting a signal into the control unit C from the camera assembly K, from the display assembly A and/or the storage assembly S.

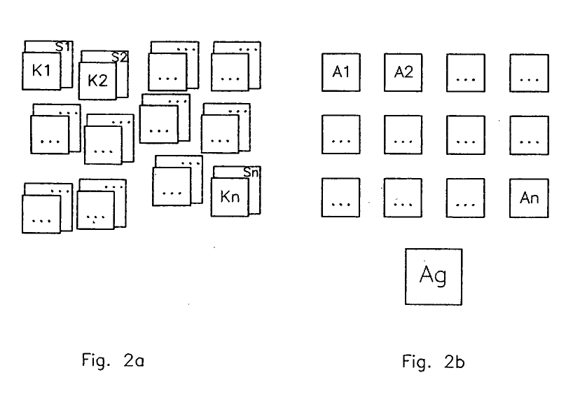

Furthermore, the control unit can comprise an input means, by means of which an operator can adjust and operate the control unit C, to consequently operate the camera assembly K, the display assembly A and/or the storage assembly S. Preferably, the storage assembly is a hard disk with high storage capacity. Moreover, as shown in FIG. 2a in more detail, a plurality of storage units S1, S2 . . . Sn can be provided, designed as RAM, enabling a temporary storage of captured pictures. The number of these plurality of storage units S1, S2 . . . Sn preferably corresponds to the number of cameras and the storage units S1, S2 . . . Sn can be located directly at the corresponding camera. This possibility of temporary storing is required particularly in such a case when the transmission rate of captured picture data from the cameras to the storage assembly is very high or too high to ensure a satisfactory transmission from a camera to the related storage assembly over an extended length of cable, as is the case if the distance between the camera and the associated storage assembly is high. The control unit C can be designed, for example, as a multitude of cluster computers.

FIG. 2a shows the camera assembly K comprising several cameras K1, K2 . . . Kn. Also shown in FIG. 2a are the storage units S1, S2 . . . Sn assigned to the cameras K1, K2 . . . Kn. The cameras K1, K2 . . . Kn are shown to be flexibly arranged. However, a camera, like K1, should be arranged with reference to another adjacent camera, like K2, such that the picture angles of the particular cameras don't show any gaps within the camera assembly. According to a preferred embodiment, at least ten cameras are provided. Preferably, one hundred cameras are provided. All cameras preferably are professional video cameras operating at high speed and having high resolution, thus are able to capture a high number of pictures per second which all are stored in the storage assembly S and, if required, temporarily stored in the storage units S1, S2 . . . Sn, to be selectively retrieved in arbitrary sequence from the storage assembly S to create a desired movie sequence.

FIG. 2b shows the display assembly A comprising a plurality of display units A1, A2. An which are preferably arranged in a matrix array and the number thereof preferably corresponding to the number of cameras K1, K2 . . . Kn in order to ensure that each picture captured by a camera K1, K2 . . . Kn can be watched directly during a recording session on the corresponding display unit A1, A2 . . . An. Moreover, in FIG. 2b, an additional display unit Ag is shown, serving first and foremost for displaying pictures and movie sequences selected from stored and/or displayed pictures.

The pictures captured by the cameras K1, K2 . . . Kn of FIG. 2a are displayed, under the influence of the control unit C, on the display units A1, A2 . . . An of FIG. 2b during the recording thereof. Thereby, the picture data can be directed, by means of the control unit C, from the cameras K1, K2 . . . Kn to the display units A1, A2 . . . An, as is shown in FIG. 1. Another possibility is to direct the picture data, under the influence of the control unit C, from the cameras K1, K2 . . . Kn directly to the display units A1, A2 . . . An; however, such embodiment is not shown in the drawings.

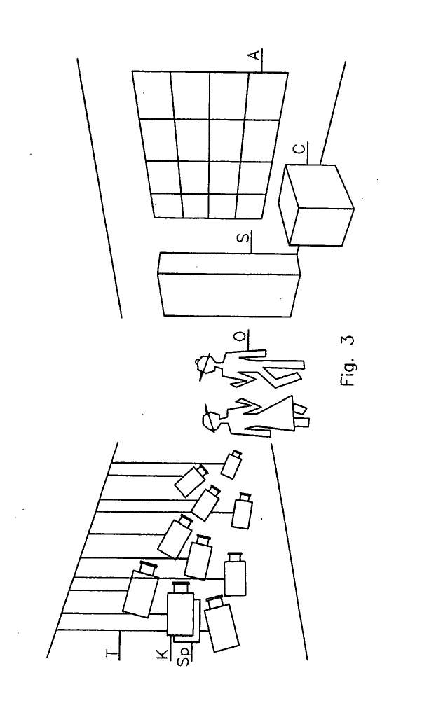

In the following, an embodiment of the entire system of the invention is explained in detail, with reference to FIG. 3. Moreover, with the help of FIG. 3, the method of the invention will be explained, too.

FIG. 3 shows a camera assembly K having several cameras, a display assembly A having several display units, a storage assembly S and a control unit C, as is already shown schematically in FIG. 1. Moreover, the presence of several storage units Sp, corresponding to the several cameras, is suggested.

Additionally, FIG. 3 also shows a support structure T and an object O to be captured.

The support structure T, to which the camera assembly is preferably freely movable attached and suspended, respectively, is preferably a simply erectable structure that can be easily disassembled, moved to another place and easily re-assembled again. Particularly preferred is a support structure comprising simply mountable modular cross beams. The cameras are movably attached thereto, preferably by means of universal joints, to be adjustable around three axes. A movement of the cameras can be controlled by the control unit C.

Thus, the control unit C controls the cameras K of the camera assembly with reference of their capture position on the support structure. Moreover, the control unit C controls the synchronization of the cameras with regard to each other with respect to their capture position, their capture operation and their picture output operation for outputting pictures for display on the display assembly A. In this connection, the control unit C also controls the display units of the display assembly A as far as their display operation is concerned.

Additionally, the control unit C controls the storage assembly S relating to its storing operation with reference both to pictures captured by the camera assembly K and to pictures displayed by the display units of the display assembly A. The storage operations, thereby, are writing and/or reading operations as well as storage management operations. All these control operations can be performed automatically, particularly after having been pre-adjusted by an operator. However, these control operations can be manually performed by a selective input by an operator.

After a calibration and/or a synchronization of the entire system has been performed by means of the control unit C, particularly a calibration and/or synchronization of the cameras K1, K2 . . . Kn in FIG. 2a and/or of the display units A1, Ar . . . An in FIG. 2b, the system can be operated by simultaneously capturing pictures of the object O by means of several cameras of the camera assembly K, whereby FIG. 3 clearly shows the adjustment of the cameras in a direction towards the object O. It is obvious that particular cameras can be selected by means of the control unit C that do not participate at the above mentioned simultaneous capturing of pictures. The simultaneously captured pictures can be displayed, during capturing, on the display units of the display assembly. Moreover, a storage of the captured pictures is performed in the storage assembly S. Then, a selection of pictures out of the stored and/or displayed pictures can be done, whereby selected pictures are displayed preferably by the particular display unit Ag shown in FIG. 2b in order to be distinguished immediately from the other displayed pictures.

Because a great number of captured pictures is stored in the storage assembly S and is available for further processing, first and foremost due to the use of high speed video cameras having a high resolution, movie sequences, for example, can be created by means of the control unit C which make an impression on the observer as if the speed of motion of the camera would be completely independent of the speed of motion of the object O, because the observer watches the movie sequences in such a way as if they were captured by a single camera.

Furthermore, the selected pictures can be further processed before they are combined to a movie sequence, if this is desired or necessary. The selected pictures, the processed pictures and/or the pictures combined to a movie sequence can be stored in the storage unit S.

Using the system for recording and playing back pictures according to the invention, the following advantages can be realized:

By providing a control unit according to the invention, the operation of the system is simplified.

By using high quality components in the system, the function of the system is improved. Particularly, the number of pictures captured per second shall be increased, such that the effect of a decoupling of the speed of motion of the camera and the speed of motion of the object is improved for an observer of a movie. A preferred goal is to achieve a capture of 10'000 pictures per second.

By using a very great number of cameras, as for example 100 cameras, better effects can be realized.

By storing a great number of captured pictures, a processing of the pictures in a hitherto unknown extent can be performed.

By the possibility of displaying all captured pictures of a recording session, the recording can be directly controlled.

By attaching the cameras to the support structure by means of universal joints, the cameras can be flexibly moved; this can be done also during recording by means of the control unit. The support structure is easily erectable due to its modular traverse construction.

In sum, by the present invention, a system and a method of recording and playing back pictures is made available which can contribute to simplify the production of movies and create interesting effects in movies due to the many optimal characteristics and improvements of the system and method as compared to the prior art.

What is claimed is:

1. A system for recording and playing back pictures of objects according to the time slice technology, said system comprising:
a camera arrangement including several cameras simultaneously capturing pictures of at least one object;
a storage assembly for storing all captured pictures;
a display assembly for displaying captured pictures; and
a control unit for controlling the camera arrangement, the storage assembly and the display assembly,
whereby said several cameras, in each case, are high speed video cameras having high resolution adapted to capture a great number of pictures per second which all are stored in the storage assembly and then can be retrieved from the storage assembly in arbitrary sequence for creating movie sequences.

2. A system according to claim 1 in which said storage assembly comprises several storage means (RAM etc.), the number of storage means corresponding to the number of cameras.

3. A system according to claim 1 in which said display assembly comprises several display means.

4. A system according to claim 3 in which the number of said several display means corresponds to the number of said several cameras, such that pictures captured by a particular camera can be displayed on a particular display means.

5. A system according to claim 4 in which a further display means is provided for displaying a picture selected from the captured pictures or a created movie sequence, whereby the control unit is adapted to automatically perform, as far as the selection of pictures is concerned, a rough pre-selection of pictures.

6. A system according to claim 1 in which, due to the multitude of captured pictures stored in said storage assembly and available for further processing, said control unit is adapted to create movie sequences which make an impression on the observer as if the speed of motion of the camera would be completely independent of the speed of motion of the object, because the observer watches the movie sequences in such a way as if they were captured by a single camera.

7. A system according to claim 1 in which said storage assembly comprises a high capacity hard disk, or a solid state storage means, or magnetic/optical storage means up to quantum storage means.

8. A system according to claim 1 in which said several cameras of said camera assembly are freely movably attached to a support structure.

9. A system according to claim 8 in which said support structure is a supporting formwork that can be disassembled and assembled.

10. A system according to claim 8 in which said control unit is adapted to control said cameras with regard to their capturing position on said support structure, with regard to their mutual synchronization considering their capturing position, and with regard to their capture operation and displaying operation.

11. A system according to claims 1 in which said control unit is adapted to control said display assembly with regard to its display operation.

12. A system according to claim 1 in which said control unit is adapted to control said storage assembly with regard to its storage operation considering the pictures captured by the camera assembly and considering the pictures displayed by said display assembly.

13. A system according to claim 12 in which said storage operations are writing and/or reading operations as well as storage managements operations.

14. A system according to claim 1 in which said control unit comprises an input device by means of which an operator can adjust the control operations.

15. A method of recording and playing back pictures of objects according to the time slice technology, said method comprising the following steps:
a) simultaneous capturing of pictures of an object by means of several cameras of a camera assembly, whereby said several cameras in each case are high speed high resolution video cameras adapted to capture a great number of pictures per second;
b) storing all of said captured pictures in a storage means;
c) displaying said captured pictures on a display assembly; and
d) selecting desired pictures from said stored pictures and/or displayed pictures and combining said selected pictures to movie sequences.

16. A method according to claim 15 in which all of said simultaneously captured pictures are displayed on particular display units of said display assembly directly at the moment of capturing.

17. A method according to claim 15 in which selected pictures or movie sequences are displayed on a particular display means of the display assembly.

18. A method according to claim 15 in which the steps a) through d) are automatically controlled by a control unit and/or are manually controlled by an operator.

19. A method according to claim 15 in which, prior to capturing pictures, a calibration and/or synchronization of the cameras and/or the display units is performed.

20. A method according to claim 15 in which said selected pictures are further processed before they are combined to a movie sequence.

21. A method according to claims 15 in which said selected pictures and/or said pictures combined to a movie sequence are stored.

22. A method according to claims 15 in which, upon selecting pictures and subsequently combining pictures to movie sequences, such movie sequences are created which make an impression on the observer as if the speed of motion of the camera would be completely independent of the speed of motion of the object, because the observer watches the movie sequences in such a way as if they were captured by a single camera.

23. A system according to claim 2 in which said display assembly comprises several display means.

24. A system according to claim 2 in which, due to the multitude of captured pictures stored in said several storage means and available for further processing, said control unit is adapted to create movie sequences which make an impression on the observer as if the speed of motion of the camera would be completely independent of the speed of motion of the object, because the observer watches the movie sequences in such a way as if they were captured by a single camera.

25. A system according to claim 1 in which said control unit is adapted to control said cameras with regard to their capturing position with regard to their mutual synchronization considering their capturing position, and with regard to their capture operation and displaying operation.

26. A system according to claim 3 in which said control unit is adapted to control said display means with regard to their display operation.

27. A method according to claims 20 in which said selected pictures, said processed pictures and/or said pictures combined to a movie sequence are stored.

28. A method according to claims 20 in which, upon selecting pictures and subsequently combining pictures to movie sequences, such movie sequences are created which make an impression on the observer as if the speed of motion of the camera would be completely independent of the speed of motion of the object, because the observer watches the movie sequences in such a way as if they were captured by a single camera.
